(19) United States
(12) Patent Application Publication
(10) Pub. No.: US 2017/0279133 A1
(43) Pub. Date: Sep. 28, 2017

(54) BIPOLAR PLATE ASSEMBLY WITH INTEGRATED SEAL FOR FUEL CELL

(71) Applicants: Daimler AG, Stuttgart (DE); Ford Motor Company, Dearborn, MI (US); Nissan Motor Co., Ltd., Yokohama-shi, Kanagawa (JP)

(72) Inventors: Ryan Blunt, Vancouver (CA); Robert Henry Artibise, Vancouver (CA); David Adam, North Vancouver (CA); Stephen Wade, Vancouver (CA); Martin Keuerleber, Stuttgart (DE)

(21) Appl. No.: 15/510,871

(22) PCT Filed: Sep. 2, 2015
(86) PCT No.: PCT/IB2015/001510

§ 371 Date: Mar. 13, 2017

Related U.S. Application Data
(60) Provisional application No. 62/053,128, filed on Sep. 20, 2014.

(51) Int. Cl. H01M 8/0276; H01M 8/028; H01M 8/0286; H01M 8/0202

(52) U.S. Cl. CPC H01M 8/0276; H01M 8/0202; H01M 8/028; H01M 8/0286

(57) ABSTRACT

A bipolar plate assembly with integrated seal for a fuel cell with a subassembly having a formed metal cathode plate bonded to a formed metal anode plate. On at least one of the plates, two raised continuous ridges are formed on the outward surface of and around the perimeter of the plate, thereby creating a channel to contain the seal. In this design, a substantial portion of the channel area on the inward surface of the plate is in direct contact with and supported by the other plate. The channel and hence the seal are thus well supported during molding and under compression in the assembled fuel cell. Further, ducts traversing the seal region can advantageously be formed without affecting the functioning of the seal.

### BACKGROUND

Field of the Invention

This invention relates to bipolar plate assemblies for fuel cells and particularly for solid polymer electrolyte fuel cells intended for applications requiring high power density.

Description of the Related Art

Fuel cells such as solid polymer electrolyte or proton exchange membrane fuel cells electrochemically convert reactants, namely fuel (such as hydrogen) and oxidant (such as oxygen or air), to generate electric power. Solid polymer electrolyte fuel cells generally employ a proton conducting, solid polymer membrane electrolyte between cathode and anode electrodes. A structure comprising a solid polymer membrane electrolyte sandwiched between these two electrodes is known as a membrane electrode assembly (MEA). In a typical fuel cell, flow field plates comprising numerous fluid distribution channels for the reactants are provided on either side of a MEA to distribute fuel and oxidant to the respective electrodes and to remove by-products of the electrochemical reactions taking place within the fuel cell. Water is the primary by-product in a cell operating on hydrogen and air reactants. Because the output voltage of a single cell is of order of 1 V, a plurality of cells is usually stacked together in series for commercial applications in order to provide a higher output voltage. Fuel cell stacks can be further connected in arrays of interconnected stacks in series and/or parallel for use in automotive applications and the like.

Along with water, heat is a significant by-product from the electrochemical reactions taking place within the fuel cell. Means for cooling a fuel cell stack is thus generally required. Stacks designed to achieve high power density (e.g. automotive stacks) typically circulate liquid coolant throughout the stack in order to remove heat quickly and efficiently. To accomplish this, coolant flow fields comprising numerous coolant channels are also typically incorporated in the flow field plates of the cells in the stacks. The coolant flow fields may be formed on the electrochemically inactive surfaces of the flow field plates and thus can distribute coolant evenly throughout the cells while keeping the coolant reliably separated from the reactants.

Bipolar plate assemblies comprising an anode flow field plate and a cathode flow field plate which have been bonded and appropriately sealed together so as to form a sealed coolant flow field between the plates are thus commonly employed in the art. Various transition channels, ports, ducts, and other features involving all three operating fluids (i.e. fuel, oxidant, and coolant) may also appear on the inactive side and other inactive areas of these plates. The operating fluids may be provided under significant pressure and thus all the features in the plates have to be sealed appropriately to prevent leaks between the fluids and to the external environment. A further requirement for bipolar plate assemblies is that there is a satisfactory electrical connection between the two plates. This is because the substantial current generated by the fuel cell stack must pass between the two plates.

In order to obtain the greatest power density possible, developers of fuel cells strive to make the fuel cell stacks smaller, and particularly by reducing the thickness of the numerous bipolar plates in the stack. In that regard, the plates making up the assembly are preferably metallic and are typically produced by stamping or forming the desired features into sheets of appropriate metal materials (e.g. certain corrosion resistant stainless steels). Two or more stamped sheets are then typically welded together so as to appropriately seal all the fluid passages from each other and from the external environment. Additional welds may be provided to enhance the ability of the assembly to carry electrical current, particularly opposite the active areas of the plates. Metallic plates may however be bonded and sealed together using adhesives. Corrosion resistant coatings are also often applied before or after assembly.

Numerous designs for metallic bipolar plate assemblies have been proposed in the art. For instance, U.S. Pat. No. 7,419,738 discloses a variety of embodiments in which at least two of the plates have a common seal element of polymer material which is injected onto the plates and by which the plates are at least partially joined to one another. The arrangement makes it possible to reduce the number individual parts necessary for assembling the fuel cell arrangement with a comparatively small number of working steps. At the same time, the seal element can mechanically fix the plates without engaging in significant additional measures. By way of the seal element, it is possible to achieve not only sealing between the individual modules, but also sealing between the individual plates of a module. Numerous variations for the specific configuration of the connection of the plates by way of the seal element are possible.

In another example, US2009/0253022 discloses a seal structure for forming a substantially fluid tight seal between a unitized electrode assembly (UEA) and a plate of a fuel cell system, the seal structure including a sealing member formed in one fuel cell plate, a seal support adapted to span feed area channels in an adjacent fuel cell plate, and a seal adapted to cooperate with a UEA disposed between the fuel cell plates, the sealing member, and the seal support to form a substantially fluid tight seal between the UEA and the one fuel cell plate. The seal structure militates against a leakage of fluids from the fuel cell system, facilitates the maintenance of a velocity of a reactant flow in the fuel cell system, and a cost thereof is minimized. In this disclosure however, the sealing member itself in the vicinity of the seal is not well supported.

Further still, EP2696418 discloses another approach for a sealing assembly that has improved mechanical properties. The seal assembly is designed so that the reaction forces between the sealing element and surround are so small that damage of the groove and/or adjacent components is avoided. The sealing assembly comprises a plate having at least one step-shaped bead, the bead having at least one counter bead lying within the bead with a counter bead base and at least one counter bead flank, where a profiled sealing element having at least one sealing lip is positioned on the opposite bead base with certain specific characteristics.

Notwithstanding the many developments to date, there remains a need for greater improvement in power density from fuel cell stacks, and particularly for automotive applications. This invention fulfills these needs and provides further related advantages.

### SUMMARY

A bipolar plate assembly with integrated seal for a fuel cell is disclosed which comprises a subassembly comprising a formed metal cathode plate bonded to a formed metal anode plate. On at least a first one of the plates, two raised continuous ridges are formed on the outward surface of and around the perimeter of this first plate, thereby creating a channel to contain the seal. In this design, a substantial portion (e.g. greater than ½) of the channel area on the inward surface of this first plate is in direct contact with and supported by the other, second, plate. The channel and hence the seal are thus well supported during molding and under compression in the assembled fuel cell. A seal is integrated to the subassembly in which the seal comprises a sealing pad within the channel and on the outward surface of the first plate. A sealing bead may optionally be included on the outward surface of the sealing pad within the channel of the first plate.

With this design, ducts traversing the seal region can advantageously be formed for various fuel cell fluids without affecting the functioning of the seal. A duct or ducts can be formed between the bonded cathode and anode plates and traverse a span under both of the two raised continuous ridges of the first plate.

In certain embodiments, the integrated seal can be provided on both sides of the bipolar plate assembly. For instance, the subassembly can comprise at least one through-hole within the channel and which passes through both the bonded cathode and anode plates. The integrated seal can then be provided such that a portion fills the through-hole and also such that a sealing pad is provided on the outward surface of the second plate. It can be advantageous to employ a plurality of through-holes within the channel for this purpose. In such embodiments, the sealing pad on the outward surface of the second plate can be flat. Further, a curl can be introduced in the periphery of the through-hole or through-holes in order to better anchor the integrated to the subassembly.

In other embodiments, a similar second channel may be provided in the second plate. That is, the second plate in the subassembly can also comprise two raised continuous ridges on the outward surface and around the perimeter, thereby creating a second channel around the perimeter of the second plate. Here too, a substantial portion (e.g. greater than ½) of the area of the second channel on the inward surface of the second plate is in direct contact with and supported by the first plate. And again, the second channel and associated seal are thus well supported during molding and under compression in the assembled fuel cell.

Such bipolar plate assemblies with integrated seals are suitable for use in fuel cells, and particularly solid polymer electrolyte fuel cells and stacks thereof, for high power density applications (e.g. automotive).

The aforementioned bipolar plate assemblies with integrated seals can be manufactured by providing a metal cathode plate and a metal anode plate, forming two raised continuous ridges on the outward surface of and around the perimeter of a first one of the cathode and anode plates, to thereby create a channel around the perimeter of the first plate. The first plate is bonded to the second plate to form a subassembly in which a substantial portion of the area of the channel on the inward surface of the first plate is in direct contact with and supported by the second one of the cathode and anode plates. Then, a first mold is sealingly engaged to the apices of the two raised continuous ridges of the first plate, liquid sealant is injected into the first mold, and the liquid sealant is cured within the engaged first mold.

In embodiments comprising one or more through-holes in the subassembly, the through-hole, or holes, is formed such that it is within the channel and passes through the bonded first and second plates. This step can be accomplished either before or after the plates are bonded together. A second mold is also sealingly engaged to the outward surface of the second plate. And liquid sealant is injected into both the first and second molds (via direct connection to either the first or second mold or both), which is then cured within the engaged first and second molds.

These and other aspects of the invention are evident upon reference to the attached Figures and following detailed description.

### BRIEF DESCRIPTION OF THE DRAWINGS

FIG. 1a shows a simplified schematic view of the outward surface of the first plate and sealing pad in an embodiment of the invention.

FIG. 1b shows a schematic cross-section view of the embodiment of FIG. 1a along section A-A.

FIG. 1c is shows a schematic cross-section view of the embodiment of FIG. 1a along section B-B.

FIG. 2 shows a schematic cross-section view of an embodiment of the prior art.

FIG. 3a shows an isometric cross-section view of a channel region in an embodiment comprising a single sealing bead on the outward surface of the sealing pad on the first plate.

FIG. 3b shows an isometric cross-section view of a channel region in an embodiment comprising five sealing beads on the outward surface of the sealing pad on the first plate.

FIG. 4 shows an isometric cross-section view of a channel region in a subassembly (i.e. absent the integrated seal) in which the channel region comprises a number of ducts traversing a span under the channel

### DETAILED DESCRIPTION

In this specification, words such as “a” and “comprises” are to be construed in an open-ended sense and are to be considered as meaning at least one but not limited to just one.

Herein, in a quantitative context, the term “about” should be construed as being in the range up to plus 10% and down to minus 10%. “Formed” refers to the process of making or fashioning a component into a certain shape or form. With regards to forming a metal plate, typically this involves a stamping or pressing process.

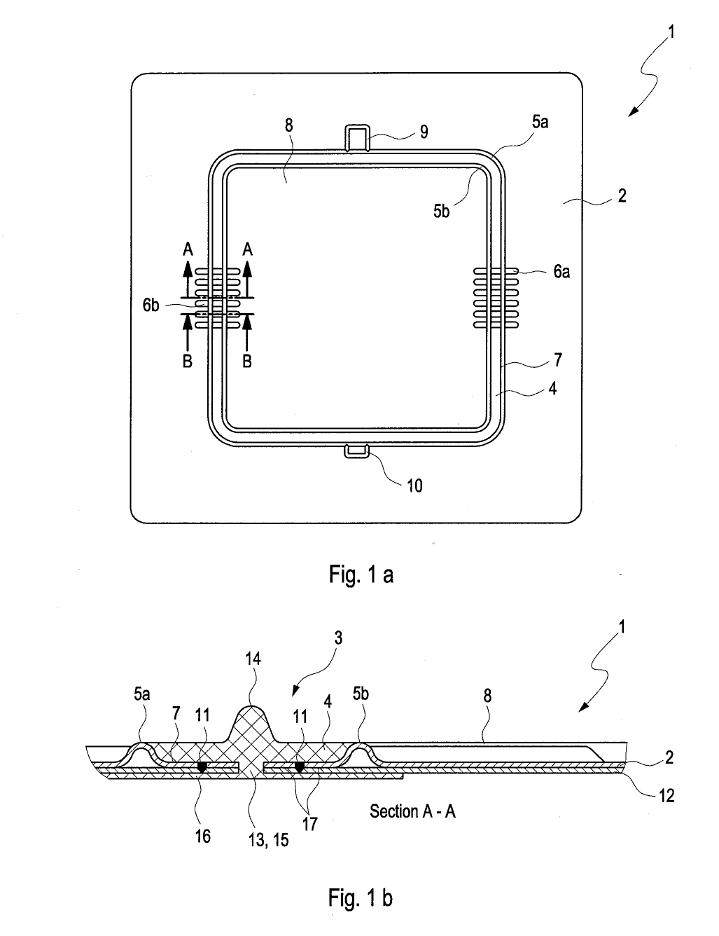

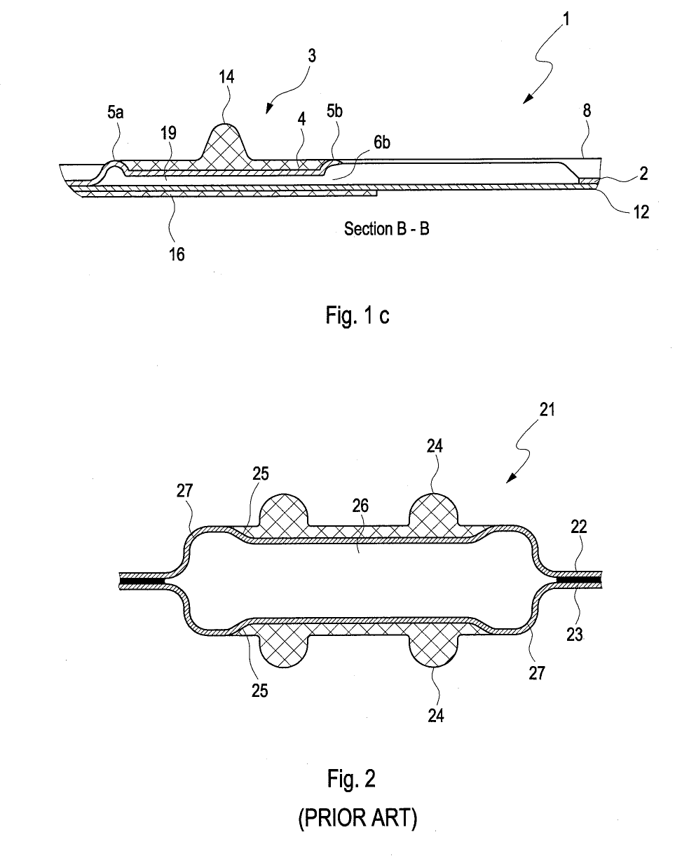

The present design for a bipolar plate assembly with integrated seal provides a channel in which to mold and locate the seal, as well as desirable support for the channel during molding and while under compression in the assembled fuel cell. FIG. 1a shows a simplified schematic view of one embodiment of a bipolar plate assembly of the invention. The outward surfaces of the first plate and sealing pad are shown.

Bipolar plate assembly 1 comprises formed metal first plate 2 bonded to formed metal second plate 12 (below first plate 2 and not visible in FIG. 1a ) and an integrated seal. Integrated seal 3 comprises sealing pad 4 (whose sealing surface is visible in FIG. 1a ). First plate 2 comprises two raised continuous ridges 5a, 5b formed on its outward surface and which appear around the perimeter of first plate 2. Ridges 5a, 5b define a channel 7 (beneath sealing pad 4 and not visible in FIG. 1a) in which sealing pad 4 is located. Two sets of formed ducts 6a, 6b are also visible in FIG. 1a. These ducts 6a and 6b provide pathways underneath channel 7 for coolant fluid to access the electrochemically inactive region between the bonded first and second plates 2, 12 and beneath electrochemically active region 8. In FIG. 1a, ducts 6a, 6b thus appear raised towards the viewer. Fluidly connected to channel 7 are injection point 9 and vent 10 which are employed in the liquid injection molding process that creates integrated seal 3. (Note that for simplicity, numerous other features in an actual bipolar plate assembly have been omitted from FIG. 1a. For instance, omitted are the reactant flow field channels and landings, transition regions, and port features usually appearing in electrochemically active region 8, along with ports and locating features usually appearing outside channel 7 near the perimeter of which typically appear in such assemblies.)

FIG. 1b shows a schematic cross-section view of the embodiment of FIG. 1a in the vicinity of ducts 6b and along section A-A which includes through-hole 13. First plate 2 is bonded to second plate 12 by a series of welds 11 (two are visible in FIG. 1b). As mentioned above, channel 7 is defined by two raised continuous ridges 5a, 5b. Through-hole 13 appears in channel 7 and passes through both first and second plates 2, 12. Integrated seal 3 in this embodiment comprises: sealing pad 4 with sealing bead 14 on the outward surface of first plate 2, portion 15 which fills through-hole 13, and sealing pad 16 on the outward surface of second plate 12. As is evident in FIG. 1b, essentially all the channel area 17 on the inward surface of first plate 2 is in direct contact with and supported by second plate 12. Thus, whenever force is applied to the apices of raised ridges 5a, 5b during a seal molding operation or to integrated seal 3 under compression in an assembled fuel cell stack, channel 7 does not deform or sag because it is fully supported by the adjacent second plate 12.

FIG. 1c shows a schematic cross-section view of the embodiment of FIG. 1a along section B-B within one of ducts 6b. The cross-section of FIG. 1c is similar to that of FIG. 1b (and like numerals have been used to identify like components) although here duct 6b provides a pathway underneath channel 7 and into the electrochemically inactive region under electrochemically active region 8. And consequently here, channel area 19 on the inward surface of first plate 2 is not in direct contact with and is not supported by second plate 12. However, the area associated with ducts 6a, 6b is small and does not allow for any significant deformation or sag of channel 7 when force is applied to raised ridges 5a, 5b or sealing bead 14.

An exemplary fuel cell stack in which to use the invention is a solid polymer electrolyte fuel cell stack intended for automotive purposes. Such stacks would comprise a series stack of generally rectangular, planar fuel cells that are separated by a number of bipolar plate assemblies 1. The membrane electrodes assemblies of the fuel cells would be located within the electrochemically active regions 8. Each sealing pad 4 in a bipolar plate assembly would then seal to the second plate in the adjacent bipolar plate assembly in the stack.

For comparison, FIG. 2 shows a schematic cross-section view of a prior art embodiment comprising a sealing assembly from EP2696418. Prior art bipolar plate assembly 21 also comprises a subassembly comprising formed metal first plate 22 bonded to formed metal second plate 23. Plates 22, 23 both have channels 25 formed therein and integrated seals 24 appear within these channels 25. However, gap 26 exists between both plates 22, 23 in the vicinity of channels 25 beneath most or all of the surface of integrated seals 24. Thus, when force is applied to integrated seals 24 under compression in a fuel cell stack or to ridges 27 during a molding operation, channels 25 can deform or sag resulting in a less effective seal and possible leakage.

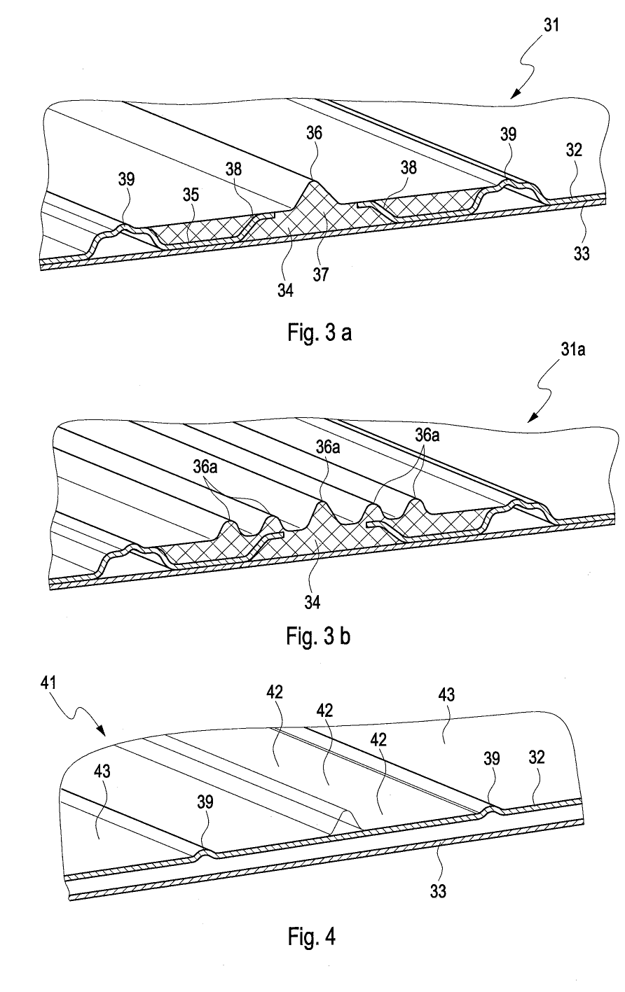

FIG. 3a shows a variant of the invention in which the periphery of the through-hole is designed to anchor the seal to the metal plate subassembly. An isometric cross-section view of the channel region is shown in FIG. 3a. Here, bipolar plate assembly 31 also comprises a subassembly of formed metal first plate 32 bonded to formed metal second plate 33. Plate 32 has two raised continuous ridges 39 having a dimpled profile formed therein which define channel 35. And integrated seal 34 appears within this channel 35. As shown, seal 34 comprises a single sealing bead 36 on its outward surface. The cross-section shown is taken through through-hole 37. In this variant, the periphery 38 of through-hole 37 is curled. Because seal 34 is molded around periphery 38, the latter serves to hold or anchor seal 34 in place.

Yet another variant of the invention is shown in FIG. 3b. Bipolar plate assembly 31a here is similar to that shown in FIG. 3a except that seal 34 comprises multiple sealing beads 36a for purposes of reducing oxygen diffusion into the fuel cell. (FIG. 3a shows five sealing beads 36a of varying height.)

FIG. 4 is provided to illustrate the structure of a metal plate subassembly of the invention in the vicinity of ducts suitable for providing a pathway underneath the formed channel. Specifically, FIG. 4 shows an isometric cross-section view of a channel region in subassembly 41 in which the channel region comprises a number of ducts traversing a span under channel 35. Channel 35 is created by continuous ridges 39 which are similar to those appearing in the embodiment of FIG. 3a. The integrated seal is absent in FIG. 4. A number of ducts have been created in subassembly 41 by forming appropriate features in plate 32. The portions of the ducts underneath channel 35 are denoted as 42, while the portions of the ducts on either side of channel 35 are denoted as 43 in FIG. 4.

The inventive bipolar plate assemblies with integrated seals can be manufactured by obtaining appropriate metal cathode and anode plate blanks and then forming two raised continuous ridges on the outward surface of and around the perimeter one or both of the plates to create the desired channels around the perimeter of the plate or plates. Other desired features, such as ducts and flow fields, also are formed into the plates. The two plates are then bonded together to form a subassembly. Importantly by design, after bonding, a substantial portion of the area of the formed channel on the inward surface of the relevant plate is in direct contact with and supported by the other plate. Note that the supporting region in the other plate does not need to be in the plane of the rest of the plate (e.g. as illustrated in FIGS. 1, 3, or 4). Instead, the supporting regions in the other plate could be formed to create an appropriate step to complement the shape of the channel in the supported plate.

Once the metal plate subassembly has been prepared, the seal can be integrated thereto by molding an appropriate sealant (e.g. silicone) to the subassembly. For instance, a first mold can be sealingly engaged to the apices of the two raised continuous ridges of the plate comprising the channel, liquid sealant can then be injected into the first mold and afterwards the liquid sealant is cured within the engaged first mold.

If it is desired that the integrated seal have sealing pads formed on both sides of the bipolar plate subassembly, through-holes are also formed in the plates (e.g. as shown in FIGS. 1b, 3a, 3b). The through-holes can be formed in the individual plates before bonding together into a subassembly. However, to minimize issues with alignment, preferably the through-holes may be formed after bonding the plates together into a subassembly. A second mold is generally required to create such intergrated seals. That is, in addition, a second mold would be sealingly engaged to the outward surface of the second supporting plate, and then liquid sealant would be injected into both the first and second molds and cured. The injecting can be accomplished by direct connection to either one or both of the first and second molds.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A bipolar plate assembly with integrated seal for a fuel cell comprising:
a subassembly comprising a formed metal cathode plate bonded to a formed metal anode plate wherein a first one of the cathode and anode plates comprises two raised continuous ridges on the outward surface of and around the perimeter of the first plate, thereby creating a channel around the perimeter of the first plate, and wherein over half of the area of the channel on the inward surface of the first plate is in direct contact with and supported by the second one of the cathode and anode plates; and
a seal integrated to the subassembly wherein the seal comprises a sealing pad within the channel and on the outward surface of the first plate.

2. The bipolar plate assembly with integrated seal of claim 1 comprising at least one duct formed between the bonded cathode and anode plates and traversing a span under both of the two raised continuous ridges of the first plate.

3. The bipolar plate assembly with integrated seal of claim 1 wherein the seal comprises a sealing bead on the outward surface of the sealing pad within the channel of the first plate.

4. The bipolar plate assembly with integrated seal of claim 1 wherein:
the subassembly comprises at least one through-hole within the channel and passing through both the bonded cathode and anode plates; and
the seal comprises a portion filling the through-hole and a sealing pad on the outward surface of the second one of the cathode and anode plates

5. The bipolar plate assembly with integrated seal of claim 4 wherein the subassembly comprises a plurality of through-holes within the channel and passing through both the bonded cathode and anode plates.

6. The bipolar plate assembly with integrated seal of claim 4 wherein the sealing pad on the outward surface of the second plate is flat.

7. The bipolar plate assembly with integrated seal of claim 4 wherein the periphery of the through-hole is curled.

8. The bipolar plate assembly with integrated seal of claim 1 wherein:
the second one of the cathode and anode plates in the subassembly comprises two raised continuous ridges on the outward surface and around the perimeter, thereby creating a second channel around the perimeter of the second plate, and
a substantial portion of the area of the second channel on the inward surface of the second plate is in direct contact with and supported by the first plate.

9. A fuel cell comprising the bipolar plate assembly with integrated seal of claim 1.

10. The fuel cell of claim 9 wherein the fuel cell is a solid polymer electrolyte fuel cell.

11. A method of manufacturing a bipolar plate assembly with integrated seal comprising:
providing a metal cathode plate and a metal anode plate;
forming two raised continuous ridges on the outward surface of and around the perimeter of a first one of the cathode and anode plates, thereby creating a channel around the perimeter of the first plate;
bonding the first plate to the second plate to form a subassembly wherein over half of the area of the channel on the inward surface of the first plate is in direct contact with and supported by the second one of the cathode and anode plates;
sealingly engaging a first mold to the apices of the two raised continuous ridges of the first plate;
injecting liquid sealant into the first mold; and
curing the liquid sealant within the engaged first mold.

12. The method of claim 11 comprising:
forming at least one through-hole in the subassembly such that the through-hole is within the channel and passes through the bonded first and second plates;
sealingly engaging a second mold to the outward surface of the second plate;
injecting liquid sealant into both the first and second molds; and
curing the liquid sealant within the engaged first and second molds.

13. The method of claim 12 comprising curling the periphery of the through-hole.
